(19) United States
(12) Patent Application Publication
(10) Pub. No.: US 2016/0140879 A1
(43) Pub. Date: May 19, 2016

(54) ANATOMICALLY CORRECT MOVEMENT OR DEFORMATION OF SIMULATED BODILY STRUCTURES

(71) Applicants: David Hananel, Minneapolis, MN (US); Jack B. Stubbs, Orlando, FL (US); Troy E. Reihsen, Woodbury, MN (US); Jason Speich, St. Paul, MN (US); Crist J. Ballas, Saint Paul, MN (US); Daniel M. Burke, Minneapolis, MN (US); Robert M. Sweet, Edina, MN (US)

(72) Inventors: David Hananel, Minneapolis, MN (US); Jack B. Stubbs, Orlando, FL (US); Troy E. Reihsen, Woodbury, MN (US); Jason Speich, St. Paul, MN (US); Crist J. Ballas, Saint Paul, MN (US); Daniel M. Burke, Minneapolis, MN (US); Robert M. Sweet, Edina, MN (US)

(21) Appl. No.: 14/946,270

(22) Filed: Nov. 19, 2015

Related U.S. Application Data
(60) Provisional application No. 62/082,049, filed on Nov. 19, 2014.

(51) Int. Cl. G09B 23/32; G09B 23/28

(52) U.S. Cl. CPC G09B 23/32; G09B 23/288

(57) ABSTRACT

An anatomical simulation model comprises a first artificial bodily structure that simulates a corresponding first anatomical structure of a living body, one or more second artificial bodily structures that simulate a corresponding second anatomical structure of the living body, and one or more connectors to connect the first artificial bodily structure to the one or more second artificial bodily structures so that the first artificial bodily structure will move substantially in an anatomically accurate manner relative to the one or more second artificial bodily structures when an outside force is applied to the first artificial bodily structure.

### CROSS-REFERENCE TO RELATED APPLICATION

This application claims the benefit of priority under 35 U.S.C. §119(e) of U.S. Provisional Patent Application 62/082,049 filed on Nov. 19, 2014, which application is incorporated by reference herein in its entirety.

### STATEMENT REGARDING FEDERALLY SPONSORED RESEARCH OR DEVELOPMENT

This invention was made with government support under grant numbers W911QX-12-C-0151 and W911NF-13-2-0033 awarded by the U.S. Army Research, Development and Engineering Command-Simulation and Training Technology Center (RDECOM-STTC). The government has certain rights in the invention.

### BACKGROUND

Simulation of medical procedures is becoming a more prominent part of medical training. Currently, artificial bodily structures, such as mannequins, are often used for simulation of medical procedures but are often anatomically different and behave differently than a human patient. Therefore, the artificial bodily structures rarely meet the fidelity needs for enhanced training, and in some cases their deficiencies can lead to negative training transfer.

### SUMMARY

The present disclosure is directed to systems comprising artificial bodily structures that have physical configurations that can accurately simulate one or more of the size, shape, feel, and movement of bodily structures within a living body, such as a human body. The simulation systems can be used for training medical or veterinary practitioners with a high-fidelity representative model that will closely and accurately simulate a patient, including movement or deformation of artificial bodily structures with respect to other artificial bodily structures within the system. The simulation systems can also be used to assist in the development of medical products, for example for testing of existing or newly-developed medical devices before testing the devices on human subjects.

In an example, the present disclosure describes a simulation model system comprising a first artificial bodily structure configured to simulate a corresponding first anatomical structure of a living body, one or more second artificial bodily structures each configured to simulate a corresponding second anatomical structure of the living body, and one or more connectors connecting the first artificial bodily structure to the one or more second artificial bodily structures so that the first artificial bodily structure will move substantially in an anatomically accurate manner relative to the one or more second artificial bodily structures when an outside force is applied to the simulation model system.

In another example, the present disclosure describes an airway simulation model comprising an artificial first passageway configured to simulate a trachea, an artificial neck structure, wherein the artificial first passageway is positioned in and extends at least partially along the artificial neck and is in communication with an artificial mouth structure, and one or more connectors connecting the artificial first passageway to the artificial neck structure so that the artificial first passageway is capable of moving in an anatomically accurate manner relative to the artificial neck structure when an outside force is applied to the artificial first passageway.

### BRIEF DESCRIPTION OF THE FIGURES

FIG. 1 is a cross-sectional view of a bodily structure simulation model comprising an artificial airway.

FIG. 2 is a close-up side view of an example of a releasable snap connector for use in connecting structures in a bodily structure simulation model.

FIG. 3A is a cross-sectional side view of a bodily structure simulation model of with an artificial head in a first position.

FIG. 3B is a cross-sectional side view of the bodily structure simulation model of FIG. 3A with the artificial head in a second position.

### DETAILED DESCRIPTION

In the following Detailed Description, reference is made to the accompanying drawings which form a part hereof. The drawings show, by way of illustration, specific examples in which the present simulation model systems and methods can be practiced. These examples are described in sufficient detail to enable those skilled in the art to practice, and it is to be understood that other embodiments can be utilized and that structural changes can be made without departing from the scope of the present disclosure. Terms indicating direction, such as front, rear, left, right, up, down, inferior, superior, anterior, and posterior are generally used only for the purpose of illustration or clarification and are not intended to be limiting. The following Detailed Description is not to be taken in a limiting sense, and the scope of the present disclosure is defined by the appended claims and their equivalents.

The present disclosure is directed to systems comprising artificial bodily structures that are configured to accurately simulate one or more of the size, shape, feel, and movement of anatomical structures within a living body, such as a human body. The simulation model system can be used for training medical or veterinary practitioners with a high-fidelity representative model that will closely and accurately simulate movement or deformation of artificial bodily structures with respect to other bodily structures within the system. The bodily structures, such as tissues or organs, can also be made from materials that provide for high-fidelity simulation of the feel and mechanical response of the corresponding bodily structures of living bodies, such as animal or human bodies.

In an example, the simulation model systems can include one or more artificial bodily structures each configured to simulate corresponding anatomical structures of a living body along with one or more connectors connecting the artificial bodily structures together. The one or more connectors can be configured so that at least one of the artificial bodily structures will move or deform substantially in an anatomically accurate manner relative to the other artificial bodily structures.

An example simulation model system can include a first artificial bodily structure configured to simulate a corresponding first anatomical structure of a living body. Examples of anatomical structures that the first artificial bodily structure can be configured to simulate include, but are not limited to, an internal anatomical bodily structure, such as an internal organ within a body, for example a human organ (e.g., a liver, lung, heart, stomach, spleen, gallbladder, pancreas, small or large intestine, brain), an internal passageway within the body (such as an airway, a blood vessel, or a digestive passageway), and an internal tissue (e.g., smooth or skeletal muscle tissue, epithelial tissue, connective tissue, or nervous tissue, skin tissue, fat tissue). The simulation model system can also include one or more second artificial body structures each configured to simulate a corresponding second anatomical structure of the living body. The one or more second artificial bodily structures can comprise any anatomical structure, such as the types of anatomical structures described above for the first artificial bodily structures, including, but not limited to, an organ, a passageway, or a tissue. The one or more second artificial bodily structures can simulate second anatomical structures that are located in proximity to the first anatomical structure in the body or that the first anatomical structure is connected to through one or more connective tissues. The one or more second artificial bodily structures can simulate one or more internal bodily structures that are in proximity to the first artificial bodily structure, e.g., internal organs, internal passageways, or internal tissues, or the one or more second artificial bodily structures can simulate an external anatomical structure, such as the outer layer of skin, fingers, toes, etc. As described in this disclosure, the realistic anatomically accurate simulation of the movement or deformation, or both, of artificial internal bodily structures can provide for realism in the simulation model beyond that which has been available. Anatomically accurate movement or deformation of artificial bodily structures can provide for accurate training of practitioners that had not been achievable with previous artificial models.

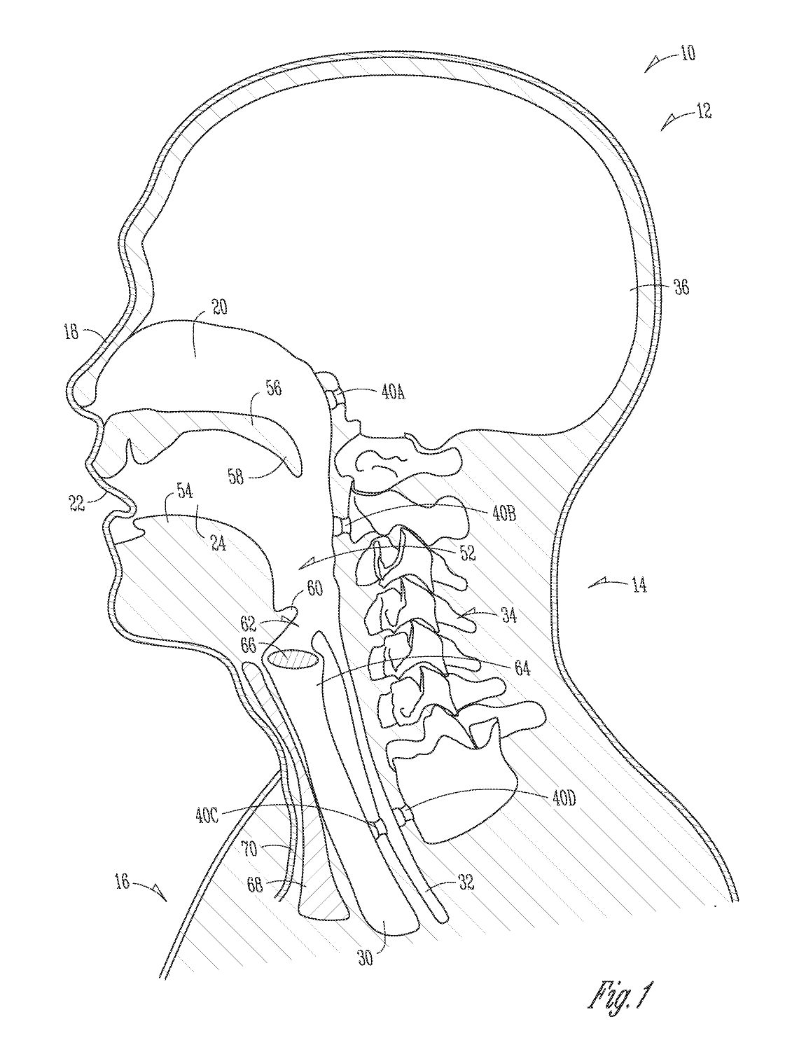

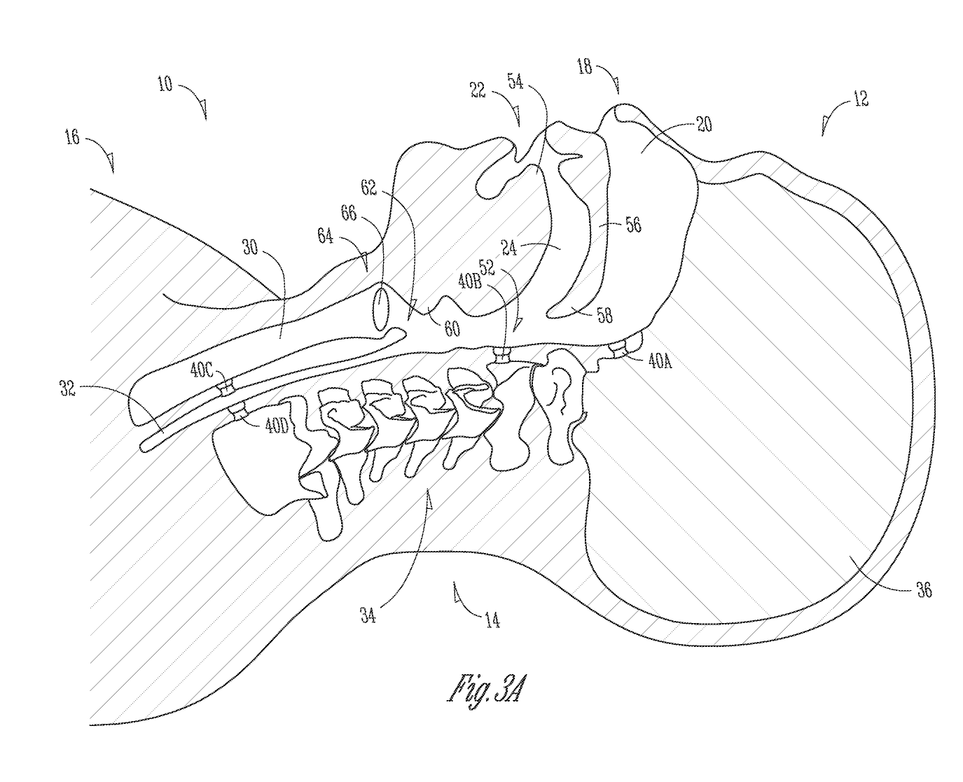

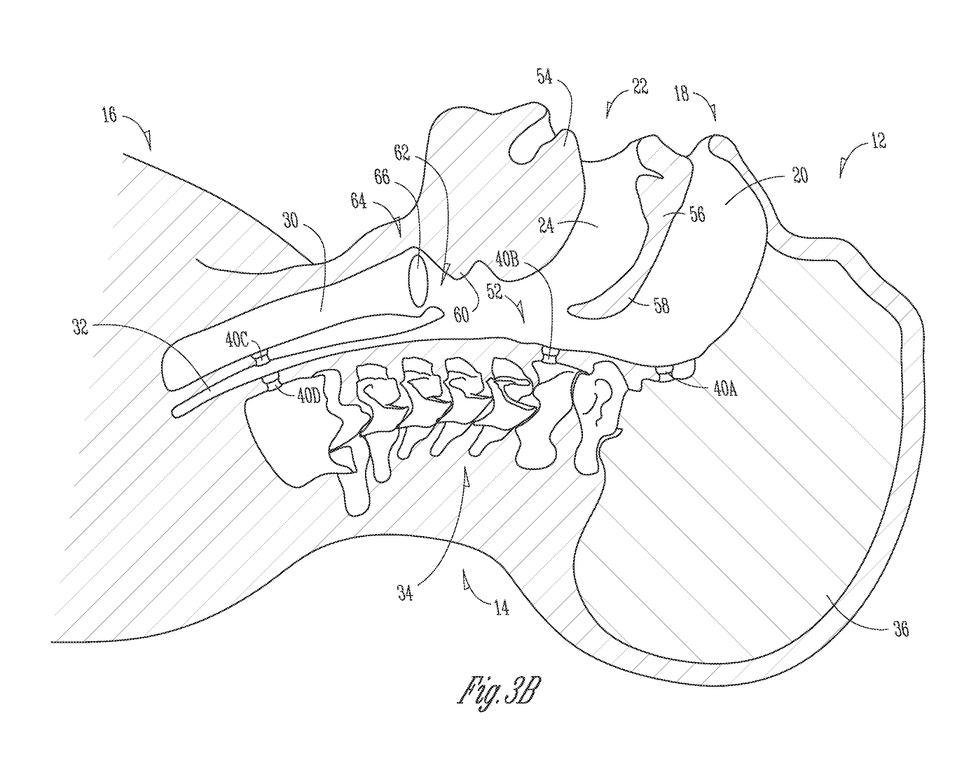

For example, as described in more detail with respect to FIGS. 1, 3A, and 3B below, if the first artificial bodily structure is a passageway configured to simulate a trachea, such as a human trachea, then the one or more second artificial bodily structures can be structures configured to simulate the esophagus, the mouth, the nasal cavity, the oral cavity, the neck (including the muscles, cartilage, and the portion of the spinal column in the neck), and the lungs,

The simulation system can also include one or more connections or connectors configured to connect the first artificial bodily structure to one or more of the second artificial bodily structures. For the sake of brevity, these connections or connectors will be referred to as connectors herein. The connectors can be configured so that the first artificial bodily structure will move or deform substantially in an anatomically accurate manner relative to one or more of the second artificial bodily structures when an outside force is applied to the first artificial bodily structure. The connectors can be selected and positioned on the first artificial bodily structure and the one or more second artificial bodily structures to simulate connective tissues within the body so that when the simulation system is subjected to an outside force, at least the first artificial bodily structure will move or deform substantially in an anatomically accurate manner relative to one or more of the second artificial bodily structures. When properly configured, the connectors can provide for added fidelity and realism for the simulation system, particularly compared to conventional medical simulators that may have some realism as far as positioning and anatomy but that do not tend to move or deform in a realistic way.

As described in more detail below with respect to the example airway simulation system 10, the one or more connectors can include, but are not limited to, releasable connecting structures such as snaps, snap-fit structures, Velcro, clasps, hooks and eyes, releasable fasteners (e.g., screws, bolts, zippers), and releasable adhesives, or non-releasable connecting structures such as welds, fasteners (e.g., nails, staples, brads), stitching, and non-releasable adhesives. In an example, all of the connectors to a particular artificial bodily structure can be releasable fasteners so that the artificial bodily structure being simulated can be removable from the system. In some examples, the connection may not be a direct physical connection, but can nevertheless provide for accurate movement or deformation. For example, the use of a diaphragm, piston, or other structure of device for the transfer or modification of air pressure can be considered a connection or connector in some situations, where the change in air pressure can provide for movement of a bodily structure, such as movement of an artificial diaphragm within an artificial chest cavity causing simulated inhalation and exhalation from artificial lungs in the chest cavity.

As used herein, the term “outside force” can refer to a force acting on the simulation system that is not part of the simulation system itself. The use of the term “outside” does not mean that the force must physically originate from outside of the system (e.g., outside of the body for a medical simulation), as some forces may occur within the system (for example a medical device that has been inserted into the system, such as a breathing tube inserted into an artificial trachea, or a scope, such as an endoscope or a laparoscope, inserted into the body). In some examples, the outside force can be applied in any direction (e.g., along all three dimensions) and at least one of the artificial bodily structures, such as the artificial internal bodily structures, will respond in an anatomically accurate manner, e.g., but moving or deforming in the same direction as would be expected by a living anatomical structure (e.g., the artificial bodily structure also moves within all three dimensions). Examples of outside forces for which a realistic simulated movement or deformation response can be simulated include, but are not limited to: a medical device acting on the simulation system, such as a device being applied to an exterior of the simulation system or being inserted into the simulation system to perform a function (e.g., a scalpel applied to an artificial tissue or a medical device inserted into the simulated body); manipulation of one or more body parts of the simulation system or the corresponding motion throughout the simulation system as connected portions move together, such as by moving or palpating the bodily structures (e.g., manually moving the head and the corresponding response to the neck and the structures therein, or movement of a thigh portion of a leg and the corresponding movement of the hip, knee, and calf portions); and a traumatic force being applied to the simulation system (e.g., a blunt force contact to the simulation system, a puncture/stabbing contact with the simulation system or a ballistic contact with the simulation system).

As used herein, the term “anatomically accurate manner,” can refer to a movement or deformation by the first artificial bodily structure when subjected to the outside force that is substantially similar to the movement or deformation of the first anatomical structure when subjected to a similar outside force. For example, the movement or deformation can be considered “anatomically accurate” when substantially the same portion of the artificial bodily structure moves in substantially the same direction and moves by substantially the same amount as the corresponding anatomical structure being simulated moves in an actual living body when subjected to substantially the same outside force at substantially the same location and with substantially the same magnitude.

The phrase “substantially the same direction” can refer to a movement or deformation of the portion of the artificial bodily structure moving in a direction of a directional vector that is substantially the same as a corresponding directional vector of the movement or deformation of a corresponding portion of the anatomical structure being simulated in a living body. One method of determining if the movement or deformation of the first artificial bodily structure is in “substantially the same direction” as the corresponding movement or deformation of the first anatomical structure in a living body is to define the vectors of movement (e.g., in a three-dimensional Cartesian coordinate system or a polar coordinate system) and then determine the angle θ between the vectors. The vectors of movement or deformation can be considered to be substantially the same if the angle θ is 20° or less, such as 17°, 15° or less, 12° or less, 10° or less, 9° or less, 8° or less, 7° or less, 6° or less, 5° or less, 4° or less, 2° or less, or 1° or less, depending on the level of fidelity desired. Another method of determining if the directional vectors are “substantially the same direction” can be to define the directional vector of movement of the artificial bodily structure and the corresponding anatomical structure being simulated using coordinates (e.g., using xyz coordinates or polar coordinates) and then take the cross product of those vectors. As is known, if two vectors have magnitudes a and b, then the magnitude of their cross product (a×b) is equal to the product of each individual vector's magnitude multiplied by sin(θ), where θ is the angle between vector a and vector b. In this way, if the angle θ is large (e.g., the vectors are not in the same direction) approaching 90°), then the magnitude of the cross product will approach the mathematical product of the magnitudes of the vectors because sin (90°) is 1. Conversely, if the angle θ is small (e.g., the vectors point in substantially the same direction as the angle θ approaches 0°), then the magnitude of the cross product will approach zero, because sin (0°) is zero. In an example, the vectors of movement of the artificial bodily structure and the corresponding anatomical structure being simulated can be considered to be “substantially in the same direction” if the magnitude of the cross product of the two vectors is 30% or less than the mathematical product of the magnitude of the two vectors, such as 25% or less, for example 20% or less, such as 19% or less, 18% or less, 17% or less, 16% or less, 15% or less, 14% or less, 13% or less, 12% or less, 11% or less, 10% or less, 9% or less, 8% or less, 7% or less, 6% or less, or 5% or less.

The phrase “substantially the same magnitude” can refer to a movement or deformation of the portion of the artificial bodily structure that is substantially the same amount as a corresponding movement or deformation of a corresponding portion of the anatomical structure being simulated. In an example, whether the magnitude of movement or deformation can be considered substantially the same can be determined by defining the movement of the artificial bodily structure and the corresponding anatomical structure as vectors with coordinates (e.g., xyz or polar coordinates, as described above) and comparing the magnitude of the resulting vectors. If the vector magnitudes are within a predetermined threshold then they can be considered to be substantially the same within the meaning of this disclosure, such as within about 25%, for example within about 20%, such as within about 15%, 14%, 13%, 12%, 11%, 10%, 9%, 8%, 7%, 6%, 5%, 4%, 3%, 2%, or 1%.

In an example, a set of points on or within the artificial bodily structure and corresponding points on or within the corresponding anatomical structure being simulated can be selected, and the movement of each point in response to a particular outside force can be measured, such as by defining the motion of each point as a vector. In an example, the motion or deformation of the artificial bodily structure in response to the outside force can be considered to be substantially similar to that of the corresponding real-life anatomical structure being simulated if each of the selected points moves in substantially the same direction and with substantially the same magnitude as that of the first anatomical structure. The selected points can depend on the procedure being simulated by the first artificial bodily structure, e.g., the points can be selected so that they are relevant to the real-life anatomical structure being simulated or to a procedure that is to be performed on the real-life anatomical structure, or both. For example, if the first artificial bodily structure is intended to simulate the human trachea when a patient is being intubated, as described below with respect to the simulation system 10, then the points of deformation used to analyze whether the artificial trachea structure moves or deforms in an anatomically accurate manner can be selected at locations of a real-life trachea that move or deform when one or more of the head, neck, or torso of the body are moved, or at locations along the trachea where a breathing tube has been found to most likely contact the trachea and in particular at the points where contact with the breathing tube can be damaging to the trachea, or both. As a higher degree of fidelity is desired, the number of the points that will be analyzed for substantially similar movement can be increased, and the locations of the points can be at more positions through the first artificial bodily structure to provide for accurate simulation of responses to a higher number of outside forces. In an example, the artificial bodily structure can be considered to move in substantially the same direction or substantially the same magnitude When at least two selected points move in substantially the same direction or with substantially the same magnitude as corresponding points of the real anatomical structure. In an example, movement can be considered to be in substantially the same direction or with substantially the same magnitude when at least 3, 4, 5, 6, 7, 8, 9, 10, 15, 20, 30 or more selected points of the artificial bodily structure move in substantially the same way as the corresponding real-life anatomical structure.

As used herein, the term “artificial” can refer to a non-naturally occurring state, and, in particular, is used herein to refer to materials being used to simulate or mimic tissues or other anatomical structures in a living animal, for example a living mammal, such as a living human. For example, when referring to an “artificial bodily structure,” artificial can refer to the bodily structure being made from materials that are different from the natural materials that form the living system of the living animal (e.g., cells, bone or other skeletomuscular structures, cartilage and other connective tissues). In examples, one or more of the materials being used to simulate or mimic the bodily structure can be man-made materials, such as organic-based polymers (e.g., polyolefins, polyesters, polyurethanes, acrylics, engineering plastics), or modified metals such as steel and aluminum. For example, artificial bodily structures comprising artificial soft tissues to simulate or mimic living soft tissue structures can be made from organosilicate-based tissue model materials, described in more detail below. Artificial bodily structures that are configured to simulate or mimic more rigid or supporting structures, such as bone or other skeletomuscular support structures, can comprise rigid or semi-rigid material, such as a rigid or semi rigid metal, e.g., steel or aluminum, or a rigid or semi-rigid polymer, such as polycarbonate, polyurethane, engineering plastics (such as polyether imides (PEI, often referred to by the trade name ULTEM) or acrylonitrile butadiene (ABS)). In other words, an artificial bodily structure can refer to a structure that closely resembles a natural, anatomical structure of a living body or feels like the natural, anatomical structure, or both, but that is not itself living or part of the living system of the living body. One or more of the artificial bodily structures of a simulation model or system

As used herein, the terms “simulate,” “simulated,” or “simulation” can refer to a system that is intended to imitate the appearance or feel and the movement or deformation of a living system in an anatomically accurate manner. For example, a bodily structure simulation system can refer to a system that is intended to imitate at least a portion of a living system, such as the human body. In particular, “simulate” or “simulation” can refer to a system that is intended to realistically imitate another system (such as the human body) for the purposes of studying the original system or to provide training on dealing with the original system, such as for medical research, development or training of medical practices, or for testing on how a living body will respond to an externally-generated force.

As used herein, the term “internal,” when referring to the artificial bodily structures, can refer to structures that are not visible from outside of the subject body and that is not accessible without removing or bypassing at least one external structure. Similarly, as used herein, the term “external,” when referring to the artificial bodily structures, can refer to structures that are visible or accessibly from the outside of the body without requiring removal or manipulation of another bodily structure.

Airway Simulation System

The concepts described above will now be described in relation to a specific example simulation system. The inventions described herein are not necessarily limited to the specific examples described herein. Rather, the example of an airway simulation system, as described below, is included, at least in part, for the purpose of illustration of the concepts described herein.

FIG. 1 shows an example airway simulation system 10. The airway simulation system 10 shown in the figures can be configured to provide for realistic simulation of one or more medical procedures to be performed on the airway of a patient, such as a human patient. In this way, the airway simulation system 10 can provide for training for medical or veterinary practitioners without having to perform on actual, living patients until the training practitioner is ready to do so. For example, the airway simulation system 10 can be configured to provide for training of endotracheal intubation (i.e., inserting a breathing tube into a patient's trachea via the mouth or nose) or a tracheotomy (i.e., making an incision through a patient's neck in order to open an air passage through the incision into the trachea). The concepts described with respect to the airway simulation system 10 can be applied to other bodily systems without varying from the scope of the present invention.

The airway simulation system 10 can include an artificial head 12 that is coupled to an artificial neck 14, which in turn can be coupled to an artificial torso 16. The artificial head 12 can include one or more orifices, such as an artificial nose 18 defining an artificial nasal cavity 20 and an artificial mouth 22 defining an artificial oral cavity 24.

The artificial neck 14 can include an artificial trachea 30 and an artificial esophagus 32 that extend from the artificial oral cavity 24 through the artificial neck 14 and into the artificial torso 16. The artificial trachea 30 can also be in fluid communication with the artificial nasal cavity 20. The artificial neck 14 can further include other artificial structures that are present within a living neck, such as a human neck. For example, the artificial neck 14 can include an artificial spine 34 extending from a base of an artificial skull 36 in the artificial head 12 through a posterior portion of the artificial neck 14. The artificial neck 14 can also include structures that simulate the feel of muscles, cartilage, tendons, and other connective or supportive tissues within an actual neck, such as a human neck.

The artificial torso 16 can include one or more other artificial anatomical structures, if desired, such as artificial lungs, an artificial heart, artificial blood vessels, an artificial ribcage, and an artificial stomach (none of which are shown in the figures). The artificial head 12, neck 14, and torso 16 can also each include artificial skin tissue; fat tissue; bone, cartilage, or other supporting structures; and ligaments or other connecting structures; on that the airway simulation system 10 can feel realistic to the touch for the training practitioner.

The airway simulation system 10 can be configured so that when one or more of the artificial head 12, neck 14, and torso 16 are moved by a user, the artificial trachea 30 will move realistically relative to the other artificial anatomical structures in the airway simulation system 10. In this way, the artificial trachea 30 can be considered to be the first artificial bodily structure that is simulating, for example, a human trachea, which can be considered the first anatomical structure, as defined and described above. The anatomically accurate movement or deformation of the artificial trachea 30 can be provided by a plurality of connectors 40A, 40B, 40C, 40D (individually referred to herein as “connector 40” or “connectors 40”) that are positioned within the airway simulation system 10. The placement and configuration of the connectors 40 can be selected so that the artificial trachea 30 will move in an anatomically accurate manner when an outside force is applied to the airway simulation system 10. Examples of an outside force with respect to the airway simulation system 10 can include, but are not limited to, moving the artificial head 12 into a predetermined position for insertion of a breathing tube, sometimes referred to as moving the head from a “sniffing” position to an extended position, palpating or otherwise moving or manipulating the artificial head 12, the artificial neck 14, or the artificial torso 16. The connectors 40 can also provide for anatomically accurate deformation of the artificial trachea 30, for example, when the artificial neck 14 is moved or deformed, such as via palpation of the artificial neck 14, and/or for anatomically accurate deformation when the artificial torso 16 is moved. In addition, the connectors 40 can provide for anatomically accurate deformation or movement of the artificial trachea 30 when a medical device is applied to the airway simulation system 10, such as a breathing tube being inserted through the artificial nose 18 or the artificial mouth 22 and into the artificial trachea 30 or (accidentally) into the artificial esophagus 32.

For many bodily systems, the actual connections within the system, e.g., via connective tissue, can be incredibly complex and thus can be difficult to completely simulate in a one-to-one manner (e.g., one artificial connector 40 for each anatomical connective structure in the human body). Therefore, in some examples, the number of connectors 40 may be greatly simplified compared to the actual number of anatomical connective structures while still providing for substantially anatomically accurate movement and deformation of the artificial bodily structure with respect to the real-life anatomical bodily structures that are of interest, such as the artificial trachea 30, or with respect to the procedure or procedures that are to be performed on the anatomical bodily structures of interest, such as an intubation procedure, or both.

In the example shown in FIG. 1, the airway simulation system 10 can include a set of two or more of connectors 40A, 40B, 40C, and 40D that are configured to provide for anatomically accurate motion of the artificial trachea 30. For example, the airway simulation system 10 can include a first connector 40A between the artificial trachea 30 and the artificial skull 36 at or proximate to the artificial nasal cavity 20. The airway simulation system 10 can include a second connector 40B between the artificial trachea 30 and the artificial spine 34 at or proximate to the artificial oral cavity 24. The airway simulation system 10 can include a third connector 40C between the artificial trachea 30 and the artificial esophagus 32 at or proximate to the joining of the artificial neck 14 and the artificial torso 16. The airway simulation system 10 can include a fourth connector 40D between the artificial esophagus 32 and the artificial spine 34 also at or proximate to the joining of the artificial neck 14 and the artificial torso 16. In an example, the airway simulation system 10 can include all four connectors 40A, 40B, 40C, and 40D, as seen in FIG. 1.

Examples of structures that can be used to form the connectors 40 include, but are not limited to, releasable connecting structures such as snaps, snap-fit structures, Velcro, clasps, hooks and eyes, releasable fasteners (e.g., screws, bolts, zippers), and releasable adhesives, or non-releasable connecting structures such as welds, fasteners (e.g., nails, staples, brads), stitching, and non-releasable adhesives. In an example, all of the connectors 40 can be releasable fasteners so that the artificial bodily structure being simulated, e.g., the artificial trachea 30, can be removed from the simulation system 10 and replaced such as if the artificial trachea 30 becomes damaged during deformation or movement, without having to replace a larger portion of the simulation system 10 or the entire simulation system 10.

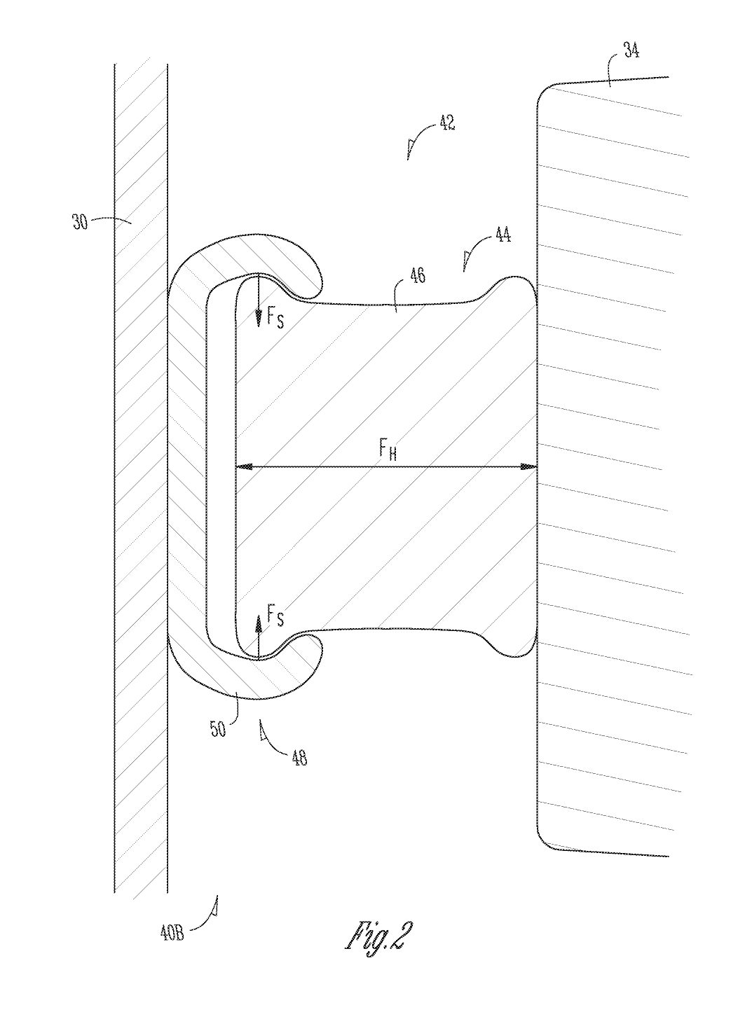

In an example, each of the connectors 40 can comprise a releasable snap. An example of a releasable snap 42 that can be used for each of the connectors 40 is shown in FIG. 2, which shows an example of the releasable snap 42 being used as the connector 40B between the artificial trachea 30 and the artificial spine 34. The releasable snap 42 can include a male portion 44, such as a post 46, which can be received by a female portion 48, such as a ring 50. One or both of the male portion 44 and the female portion 48 can be deformable and resilient, such as by being made from a deformable and resilient material or by being structured to provide deformation and resilience. The deformable and resilient structure can provide a gripping force between the male portion 44 and the female portion 48. For example, the ring 50 of the female portion 48 can be made of a metal that is configured to provide a spring force F_{S} that is exerted inward toward the post 46 when the post 46 is inserted into the ring 50, as shown in FIG. 2.

In an example, one of the male portion 44 and the female portion 48 can be mounted to the artificial bodily structure (e.g., the artificial trachea 30 in FIG. 2), and the other of the male portion 44 and the female portion 48 can be mounted to the structure to which the artificial structure is to be connected (e.g., to the artificial spine 34 in FIG. 2). For each connector 40 that is releasable, such as a snap or Velcro, the connector 40 can provide a holding force F_{H} that is strong enough to withstand disengagement when exposed to predetermined forces that will be exerted on the connector 40 by typical motion of the simulation system, such as movement of the artificial head 12, the artificial neck 14, or the artificial torso 16 in the airway simulation system 10, but low enough so that the connector 40 can be disengaged relatively easily, e.g., by hand, so that the connectors 40 can be disengaged to provide for replacement of the artificial bodily structure connected into the system with the releasable connectors 40.

The number and location of the connectors 40 can be determined from careful examination of the bodily system or systems that the simulation model is intended to simulate, such as the human airway for the airway simulation system 10 shown in FIG. 1. In an example, the number and position of the connectors 40 can be determined by first performing scans of the anatomy of a human subject, such as a magnetic resonance imaging (MRI) scan, with the head, neck, and torso of the subject in various positions to determine the location of various points along the trachea at several points in time during the motion of the head, the neck, and the torso. Testing of various positions of the connectors has shown that placing the connectors 40 at the positions of connectors 40A, 40B, 40C, and 40D, as described above, can provide for anatomically accurate deformation and movement of the artificial trachea 30. For example, the first connector 40A connecting the artificial trachea 30 to the artificial skull 36 at or proximate to the artificial nasal cavity 20 can provide for anatomically accurate movement of the superior terminus of the artificial trachea 30, e.g., at a superior portion of the artificial pharynx 52, when the artificial head 12 moves (e.g., tilts, rotates, tips, or otherwise moves relative to the artificial neck 14). The second connector 40B connecting the artificial trachea 30 to the artificial spine 34 at or proximate to the artificial oral cavity 24, e.g., at a middle portion of the artificial pharynx 52, can provide for anatomically accurate movement of the artificial trachea 30 at an upper medial portion of the artificial trachea 30 as the artificial neck 14 twists or tips. The third connector 40C connecting the artificial trachea 30 to the artificial esophagus 32 can provide for anatomically accurate movement of the artificial trachea 30 relative to the artificial esophagus 32, and vice versa. The fourth connector 40D connecting the artificial esophagus 32 to the artificial spine 34 can provide for anatomically accurate movement of the artificial esophagus 32 relative to a lower portion of the artificial neck 14 and the artificial torso 16 (e.g., as the artificial neck 14 tilts, rotates, or otherwise moves relative to the artificial torso 16). The fourth connector 40D can also provide for anatomically accurate movement of the artificial trachea 30 relative to the lower portion of the artificial neck 14 and the artificial torso 16 because of the close proximity of the fourth connector 40D to the third connector 40C that connects the artificial trachea 30 to the artificial esophagus 32.

Connectors in addition to the connectors 40A, 40B, 40C, 40D can also be included, such as one or more of a connector between the artificial trachea 30 and an artificial muscle within the artificial neck 14, a connector between the artificial trachea 30 and a cartilage structure within the artificial neck 14, or a connector between the artificial trachea 30 and an artificial bone structure other than the artificial spine 34, such as an artificial mandible or an artificial breast plate.

The configuration of the connectors 40 described above and shown in FIG. 1 can be particularly useful for an airway simulation system 10 that is designed to provide training to a practitioner in performing endotracheal intubation, also referred to herein simply as “intubation,” e.g., inserting a breathing tube through the mouth or the nose and into the trachea. Intubation can be a difficult medical procedure to master because of the tortuous route and the delicate anatomical structures that the breathing tube must pass by in order to reach the trachea. This difficult path can be seen in reference to the airway simulation system 10 shown in FIG. 1, for example, which has been produced to identically or nearly identically match the configuration of a human patient. If a breathing tube is to be inserted through the mouth, as is typical, the end of the breathing tube must first be fed in a posterior direction (e.g., from a front toward the back of the body) and pass through the artificial oral cavity 24, while avoiding contact with an artificial tongue 54 and an artificial palate 56. The path of the end of the breathing tube must then be turned in the inferior direction (e.g., from artificial head 12 toward the artificial torso 16) to avoid contact with an artificial uvula 58 and the posterior wall of the throat as the breathing tube passes through the artificial pharynx 52. The breathing tube can continue to be fed in the inferior direction through the artificial pharynx 52 until the end of the breathing tube is beyond an artificial epiglottis 60, then the end of the breathing tube will be turned back in an anterior direction (e.g., from the back toward the front of the body) so that the end of the breathing tube will pass into the artificial trachea 30 via an artificial laryngeal inlet 62 rather than into the artificial esophagus 32. In some examples, the end of the breathing tube may also be required to pass through an artificial larynx 64 (voice box) with artificial vocal cords 66 without damaging the inner walls of the artificial larynx 64 or the artificial vocal cords 66.

Adding to the difficulty of the intubation procedure is the fact that the path that the breathing tube will take can change depending on the relative positions and orientations of the head 12, the neck 14, and the torso 16. FIGS. 3A and 3B demonstrate an example of this changing path. FIG. 3A shows a side cross-sectional view of the airway simulation system 10 resting in a generally flat supine position with the artificial head 12 being generally aligned with the artificial neck 14. FIG. 3B shows a cross-sectional side view of the airway simulation system 10 with the artificial head 12 being tipped upward relative to the artificial neck 14, sometimes referred to as a “sniffing position.” As can be seen by a comparison between FIGS. 3A and 3B, for example, the pharynx 52 can be shallower in the anterior-posterior direction when in the flat supine position (FIG. 3A) compared to the sniffing position (FIG. 3B), when the pharynx 52 can be wider. Also, one or both of the laryngeal inlet 62 and the trachea 30 at the larynx 64 can be slightly wider when in the sniffing position (FIG. 3B) when compared to the flat position (FIG. 3A). There can also be a different angle between the oral cavity 24 and the pharynx 52 and between the pharynx 52 and the trachea 30 when the head 12 is in the flat supine position (FIG. 3A) versus when it is in the sniffing position (FIG. 3B). In short, the path through which the end of the breathing tube must be fed is different when the relative positions of the head 12, the neck 14, and the torso 16 are different.

The connectors 40 can be configured to provide for anatomically accurate deformation or movement (or both) of the artificial trachea 30, for example, due to one or more of: tilting of the artificial head 12 up and down along the sagittal plane (e.g., when moving between the flat supine position show in FIG. 3A and the sniffing position shown in FIG. 3B); tiling of the artificial head 12 side to side in the coronal plane; and due to forces exerted by the breathing tube or another external force onto one or more body parts in the airway simulation system 10, in particular the trachea 30 or adjacent or proximal body parts, such as a force exerted onto one or more of the nose 18, the nasal cavity 20, the mouth 22, the oral cavity 24, the esophagus 32, the pharynx 52, the epiglottis 60, the larynx 64, and the vocal cords 66. As noted above, the connectors 40 can provide for anatomically accurate movement of the artificial trachea 30 and other airway structures (e.g., the artificial pharynx 52, the artificial epiglottis 60, the artificial laryngeal inlet 62, the artificial larynx 64, and the artificial vocal cords 66) when parts of the airway simulation system 10 are moved, such as the artificial head 12 or the artificial neck 14. In addition to, or in place of, the anatomically accurate movement, the connectors 40 can provide for anatomically correct deformation of the artificial trachea 30 and other airway structures by restraining certain movement of the artificial trachea 30 and, in some examples, one or more of the other airway structures when contacted by a medical instrument, such as an breathing tube, in the same or similar manner that connective tissues in a living body does. For example, the first connector 40A can restrain the potential movement of the superior end of the artificial trachea 30, e.g. at the artificial pharynx 52 proximate to the nasal cavity 20, that can occur if the artificial pharynx 52 is contacted by the breathing tube. Similarly, the connectors 40B, 40C, and 40D can limit movement or deformation at more inferior positions along the airway, such as the second connector 40B proximate to the oral cavity 24 at the pharynx 52, and the third connector 40C and the fourth connector 40D can limit movement or deformation of the trachea 30 proximate to the artificial torso 16.

In some examples, the type of connectors 40 can affect how much the particular connector 40 will limit movement or deformation of the artificial bodily structure, e.g., the artificial trachea 30. One type of connector, as used herein, can be a connector that is connected directly to a second artificial bodily structure, such as a support structure, also referred to herein as primary connectors, so that it connects a relatively deformable bodily structure to a relatively stiff, solid, or non-deformable structure. Examples of primary connectors in the airway simulation system 10 include the connectors 40A, 40B, and 40D, which connect a deformable bodily structure (e.g., the artificial trachea 30 for connectors 40A and 40B and the artificial esophagus 32 for connector 40D) to a relatively solid, non-deformable bodily structure (e.g., an artificial bone structure such as the artificial skull 36 or the artificial spine 34 or a particularly stiff part of artificial cartilage). The connectors 40 can also include one or more connectors that provide a connection to a second deformable structure, also referred to herein as secondary connectors, wherein the second deformable structure may or may not be connected to a support structure by a primary connector. For example, the third connector 40C is between the deformable artificial trachea 30 and the deformable artificial esophagus 32, while the artificial esophagus 32 is further supported by the primary connector 40D to the artificial spine 34. Primary connectors, such as connectors 40A and 40B can provide for more limited movement or deformation of the artificial trachea 30 compared to a secondary connector, such as the third connector 40C. By tailoring the use of primary connectors and secondary connectors in body simulation structures, the amount and direction of deformations can be controlled somewhat to provide for desired levels of accuracy when compared to living systems.

Materials of Tissues and Organs

The materials that can be used to form the artificial tissues or organs of the simulation models described above, such as the airway simulation system 10 described with respect to FIGS. 1, 3A, and 3B, can be designed with one or more physical properties that are highly representative of the same physical properties of a live tissue or organ that is to be simulated by the artificial tissues or organs, referred to herein as a tissue model. For example, a tissue model can be designed to simulate a particular human tissue (such as muscle tissue 68 or skin tissue 70 of the artificial neck 14 in the airway simulation system 10) by substantially matching mechanical properties (such as viscoelastic properties, nanoindentive properties, strain rate insensitivity, compressibility, stress-strain curves, Young's modulus, yield stress, tear point, deformability, and the like), electroconductive properties, thermoconductive properties, optical properties, chemical properties, and anisotropic properties of the native tissue.

In an example, silicone-based materials are useful in simulation and biomedical applications. Silicon is an element that is rarely found in its elemental form but can be found as oxides or as silicates. Silica is an oxide with formula SiO₂ that can have amorphous or crystalline structure. Silicates are salts or esters of silicic acid (general formula [SiOx(OH)_{4-2X}]ₙ) that contain silicon, oxygen, and metal elements. Silicones are polymers made of silicon, oxygen, carbon, and hydrogen with repeating Si—O backbone (Colas, 2005). These polymers are created synthetically with the addition of organic groups to the backbone via silicon-carbon bonds. A common silicone is polydimethylsiloxane (PDMS) with monomeric repeat unit [SiO(CH₃)₂]. The number of repeat units and degree of cross-linking within the silicone polymer can account for the different types of silicone materials available for different applications. Silicones have been used in biomedical applications because of their high biocompatibility, their chemical inertness, and their resistance to oxidation.

In an example, the material of the tissue model can comprise platinum based silicone-rubbers, tin cured silicone rubbers or urethane rubbers. Examples of base materials are presented in Table 1. Table 2 provides examples of foams and additives that can be used with the base materials.

TABLE 1
Organosilicate base materials

| Type | Category | Company | Product Trade Name |
|---|---|---|---|
| Bases | Tin Cured | Smooth-On, | Mold Max Series |
| | Silicone | Inc. | |
| | Rubber | Smooth-On, | Mold Max T-series |
| | | Inc. | |
| | | Smooth-On, | Mold Max STROKE |
| | | Inc. | |
| | | Smooth-On, | Mold Max XLS II |
| | | Inc. | |
| | | Smooth-On, | OOMOO Series |
| | | Inc. | |
| | | Polytek | TinSil 70& 80 Series, |
| | | Development | |
| | | Corp, | |
| | | Dow Corning | Silastic Series |
| | | Corp. | |
| | | Silicones, Inc. | Gl-650, 384, 1000, 1032, 1040, 1100, 1120, |
| | | | 1210, 1220, 184 |
| | | Silicones, Inc. | XT 153, 177, 314, 385, 386, 426, 464, 475, |
| | | | 479, 493, 585 |
| | Platinum | Smooth-On, | Mold Star 15, 16, and 30 |
| | Based | Inc. | |
| | Silicon | Smooth-On | Smooth-Sil |
| | Rubbers | Smooth-On, | Dragon Skin Series (incl Fx Pro) |
| | | Inc. | |
| | | Smooth-On, | Ecoflex Series |
| | | Inc. | |
| | | Smooth-On, | Rebound 25 and 40 |
| | | Inc. | |
| | | Smooth-On, | Sorta Clear |
| | | Inc. | |
| | | Smooth-On, | Body Double |
| | | Inc. | |
| | | Smooth on | Skin Tite |
| | | Smooth-On, | Psycho Paint |
| | | Inc. | |
| | | Polytek | Platsil Series 71, 73, and Gels |
| | | Development | |
| | | Corp. | |
| | | Dow Corning | Silastic Series |
| | | Corp. | |
| | | Dow Corning | Xiameter Series |
| | | Corp. | |
| | | Silicones, Inc. | P series (incl. 656, FDA, 157, 125, 100, 90, |
| | | | 70, 60, 50, 45, 44, 20, 17, 15, 4, 10, 149, 163, |
| | | | 268, 288) |
| | | Silicones, Inc. | XP series (incl. 149, 163, 288, 344, 368, 378, |
| | | | 382, 429, 450, 536, 541, 549, 550, 573, 657) |
| | | NuSil | LSR elastomers (Med 4805, 4810, 4815, |
| | | Technology | 4820, 4830, 4840, 4842, 4714, 4905, 4900 |
| | | LLC | Series, 50/5800 series) |
| | | NuSil | VersaSil (Med4032) |
| | | Technology | |
| | | LLC | |
| | | NuSil | Optical Elastomers (LS-1200 and LS- |
| | | Technology | 3200/3300series) |
| | | LLC | |
| | | EnvironMolds, | LifeRite Series |
| | | LLC | |
| | | EnvironMolds, | MoldRite Series (25) |
| | | LLC | |
| | | EnvironMolds, | SkinRite Series (10 |
| | | LLC | |
| | | Renew | Silicone (00-30/50, 5, 10, 20 replicator) |
| | | Advanced | |
| | | Materials, Inc. | |
| | | Primasil | Sil 100 & 400 series |
| | | Silicones Ltd. | |
| | | Alumilite | High Strength 2 & 3 |
| | | Corp. | |
| | | 3M Co. | Impregum, Soft/DuoSoft Polyethers |
| | | 3M Co. | Imprint 3, Express 2 VPS, (3M ESPE series) |
| | Urethane | Smooth-On, | Clear Flex 50 & 95 |
| | Rubber | Inc. | |
| | | Smooth-On, | Renew UR 40, 60, 80, 90 |
| | | Inc. | |

TABLE 2
Additives

| | | | |
|---|---|---|---|
| Foams | Rigid and | Smooth-On, Inc. | Foam-it 3, 5, 8, 10, 15, 26 |
| | Flexible | Smooth-On, Inc. | Foam-iT III,, V, X, 17, 25 |
| | Foam | Smooth-On, Inc. | Soma Foama - 15 |
| | | Renew Advanced | Rigid Foam 10, Flexible foam 10, 25 |
| | | Materials, Inc. | |
| Additives | Silicone | Smooth-On, Inc. | Thi-Vex Silicone Thickener |
| | Rubber & | Smooth-On, Inc. | Silicone Thinner |
| | Urethane | Smooth-On, Inc. | Cryptolyte |
| | Accessories | Smooth-On, Inc. | Slacker - deadener |
| | | Smooth-On, Inc. | URE-FIL 9 |
| | | Polytek | TinThix |
| | | Development | |
| | | Corp. | |
| | | Polytek | PolyFiber II |
| | | Development | |
| | | Corp. | |
| | | Polytek | Fumed Silica |
| | | Development | |
| | | Corp. | |
| | | Polytek | Polyfil ND |
| | | Development | |
| | | Corp. | |
| | | EnvironMolds, | ThickRITE |
| | | LLC | |
| | Coloring | Smooth-On, Inc. | So-Strong Color Tints |
| | | Smooth-On, Inc. | Ignite - Flourescent Pigments |
| | | Smooth-On, Inc. | Sil-Pig - Silicone Pigments |
| | | EnvironMolds, | Cirius Paint Series |
| | | LLC | |
| | | EnvironMolds, | Cirius Pigment Series |
| | | LLC | |
| | | NuSil Technology | Med Series (4102, 4502, 4800, 4900) |
| | | LLC | through Gayson Silicon Dispersions, |
| | | | Inc. (GSDI) |

I an example, described in further detail below, the tissue model can be formed from an organosilicate base material and can optionally include one or more additives that can be included with the organosilicate base material to modify one or more physical properties of the organosilicate base material.

Organosilicate materials are stable and do not call for specialized storage or shipping. These materials are cost effective and are less expensive compared to animal and cadaveric models. The material is durable and can often be reused which also adds to cost-effectiveness.

The organosilicate polymer base material can be mostly clear in color and can be capable of being cured in room air or within a mold. The polymer base material can be mixed thoroughly with additives, resins, or indicators to allow for equal distribution of the base throughout the combined mixture. The mixture can be placed in a mold to form a molded sample layer by layer. Once fully cured, the mold can be de-cast, and the molded sample can be coated with a talcum powder and washed with cold water to remove excess talcum powder.

Possible modifications affecting viscoelastic properties can include ratio changes, chemical additives and ultraviolet (UV) light exposure. For example, organosilicate films that are exposed to an ultraviolet light source have at least a 10% or greater improvement in their mechanical properties (i.e., material hardness and elastic modulus) compared to the as-deposited film (U.S. Pat. No. 7,468,290). The UV light has been shown to cause increased cross-linking in the material, which can increase the modulus and decrease the elasticity (Crowe-Willoughby et al., 2009). In some examples, the intensity and duration of UV exposure can he modulated to provide for fine-tuning of desired mechanical properties.

The completed tissue models can he used in combination with other substances in order to replicate a clinical situation. The organosilicate based tissue models can be used in the absence of silicone spray and can instead be implemented with inexpensive clinical substitutive artificial blood, saliva, urine, or vomit.

Examples of types of tissues that can be formed using the organosilicate base materials of the present disclosure include, but are not limited to; fat, connective tissues, nerve, artery, vein, muscle, tendon, ligaments, renal artery tissue, kidney tissue, ureter tissue, bladder tissue, prostate tissue, urethra tissue, bleeding aorta tissue, pyeloplasty tissue, Y/V plasty tissue, airway tissue, tongue tissue, complete hand tissue, general skin tissue, specific face skin tissue, eye tissue, brain tissue, vaginal wall, breast tissue, nasal tissue, cartilage, colon tissue, stomach tissue, liver tissue, rectum, and heart tissue.

In an example, the organosilicate base can be a soft, room temperature vulcanized (RTV) silicone rubber with a hardness of less than 30 shores. The two-part component can be addition cured and platinum catalyzed to result in high tear strength and flexible mold compounds. The organosilicate base can bond to plastics. The percentage of mixing of A and B change depending on the application of the tissue model.

In an example, a platinum salt in portion B (OSHA PEL and ACGIH threshold limit value 0.002 mg/m³ (as Pt)) has the following technical specifications.

| | | |
|---|---|---|
| a. | Mix ratio, by weight | 1A:1B |
| b. | Hardness, Shore A | 10 ± 2 |
| c. | Pour time, minimum | 6 min |
| d. | Demould time @ 25° C. (77° F.) | 30 min |
| e. | Color | off white |
| | | translucent/Colorless |
| f. | Viscosity, mixed | 15,000 cP |
| g. | Specific volume (in 3/Ib) | 25 |
| h. | Specific gravity @ 25° C. (77° F.) | 1.10 |
| i. | Shrinkage upon cure | Nil |
| j. | Flash point >350° F. | |

In an example, a tissue-specific organosilicate base material is formed onto the three-dimensional printed model, such as by painted layering, casting, depositing, molding, and the like. The organosilicate base material conforms to the details of the model to create an exact replica of the patient specific anatomy.

In an example, an organosilicate material can be added in precise layers to imitate the physiologically distinct layers found in skin and other living tissues. In an example, a first layer of a first organosilicate material can be applied to the three-dimensional printed model and allowed to cure to simulate a first layer of tissue. A second layer of a second organosilicate material can be applied to the first layer, wherein the second organosilicate material can be different than or the same as the first organosilicate material and allowed to cure to simulate a second layer of tissue. Subsequent layers (e.g., a third, fourth, and fifth layer, etc.) can be added over the second layer. The layers might not all be cured in between if the layers are to be inseparable. However, substances, devices, sensors can be added between or within each layer.

In an example, one thick layer of a first organosilicate material or a plurality of thin layers of the first organosilicate material can be applied to the three-dimensional model in order to simulate a substantially uniform tissue structure or layer. Once the material layer or layers have been added to the desired thickness, the outer material can be separated from the mold and sealed.

In an example, Smooth-On thinners are used and such thinners are applicable to all platinum cured silicones. The thinner can be composed of 100% dimethylsiloxane (CAS number 63148-62-9). Adding the thinner to the organosilicates can decrease the viscosity and durometer of the final material. The ultimate tear strength and tensile stress can also be reduced in proportion to the amount of thinner added. In an example, the maximum amount of thinner that can be added to a recipe is 15% of the weight of part A.

Additives can be added to reduce tackiness, decrease cross linking of the polymers (which makes them more fragile), increase lubricity (for a more viscous “feeling”), or increase the electrical conductive nature of the materials. In an example, the additives can include a silicone oil such as Dow Corning 200(R) fluid, 1CST (01013092) or octamethlyrtrisiloxanes (>60%). In an example, the additives can be at least one of petroleum jelly, glycerin, baby oil, talcum powder, colors, tints, dyes, metal wires, metal powders, nanotubes, theromochromatic pigments, slurries, water, and ink. Further, the additives can also be at least one of germanium wires, copper powders, nickel powders, dielectric inks, and dielectric coatings.

In an example, sensors can be positioned on or between a layer or layers of the organosilicate tissue model or imbedded within one or more layers of the tissue model for measuring deformation of the tissue model upon contact or collision with objects such as surgical instruments, hands of a medical practitioner or other organs such as bones.

In an example, a piezoelectric film that can detect pressure or deformation can be used, such as the pressure or force sensing films sold by Tekscan, Inc. (South Boston, Mass. USA).

In an example, at least one of a strain gauge, a capacitive diaphragm, an electromagnetic inductance diaphragm, an optical strain detection sensor, a potentiometer mechanism, a vibration sensor, an accelerometer, adynamic switch element, and a piezoelectric sensor can be positioned on or between or imbedded within any layer of the tissue model. In an example, the sensor can produce a voltage signal in proportion to a compression force, or a tensile mechanical stress or strain. Piezoelectric sensors, such as a piezoelectric film or fabric can also be well suited for high fidelity tissues with audio in the high frequency (e.g., greater than about 1 kHz) and ultrasound frequency (e.g., up to 100 MHz) ranges, such as for ultrasound detection, Piezoelectric sensors can be in the form of cables, films, sheets, switches, and can be amplified in a laboratory setting.

In an example, a piezoresistive sensor can be used to measure deformation of the tissue model material at a particular location. In an example, a piezoresistive fabric can be imbedded on, within, or between layers of the tissue model to provide contact and deformation detection with minimal delay in response or recovery time (over 400 Hz). A small delay in response or recovery time allows for haptic data of the interactions to be collected and for a dynamic response to be performed.

In an example, EeonTex flexible fabric (also known as e-fabric), sold by Eeonyx Corporation (Pinole, Calif. USA) can be used as a piezoelectric sensor that can conform with three-dimensional surfaces can be used.

In an example, a sensor can be located at an expected deformation site. For example, while intubating the airway of an artificial tissue analogue, one or more sensors can be placed in at least one of an artificial tongue, an artificial larynx, an artificial pharynx, artificial vocal cords, and an artificial bronchii because these locations are known as collision sites where damage has occurred by improper technical or procedural technique. In an example, a sensor or sensors can be located near an incision site for the tissue model in order to measure the depth, pressure, and forces (with direction) of any movement of the tissue.

In an example, flow sensors can be imbedded into the tissue in order to measure flow rate, for example of artificial blood flowing through the tissue model.

In an example, leak testing pressure sensors can be used to send the decay of pressure in an closed loop artificial artery or vein due to an accidental or purposeful cut, incision, or needle stick of the wall of the model. Quantifying the amount of fluid loss can be associated with blood loss in a patient during procedures, which can be related to outcomes and safety metrics.

In an example, determining the physical shape that the tissue model will take comprises creating a patient specific three-dimensional physical model via life casting, computer tomography (CT scan), or magnetic resonance imaging (MRI) datasets. In an example, DICOM imaging stacks are processed through compositing software (e.g., After Effects®) to identify and isolate the specific anatomical structure. The refined stack data can be processed through image segmentation software (e.g., Mimics®) to create a coarse three-dimensional model of the selected anatomy. The coarse model can be brought into a three-dimensional development package (e.g., Maya®) and used as a reference so that a new, clean model can be built over the previous model. The model can be further refined to the desired level of detail. The process can be guided by a physician or a subject matter expert. The subject matter experts include but not limited to engineers, physicians, anatomists, physiologists or biochemists.

In an example, forming the tissue model comprises sending the finalized virtual three-dimensional model to a three-dimensional printer that utilizes stereolithographic techniques to produce a three-dimensional printed model prototype or negative which is cast, created, or molded using the organosilicate base material determined from the tissue database.

The completed model can undergo face and content validation studies and testing by clinical and or anatomy subject matter experts in the training environment to inspect any possible anatomical deviations. The anatomical deviations can include poor color mapping, visible seams or extra material pieces. Any abnormalities can be noted and corrections can be made to the protocol regarding the building of future models. As part of a curriculum, the models are assessed for their ability to provide face, construct, content, discriminate, concurrent, convergent, and predictive validity.

Stereolithography is advantageous due to the ability to rapidly create prototypes (typically less than one day). The resulting prototypes are durable and reusable as a positive or negative for tissue castings, adding to the cost-effectiveness of using stereolithography. The patient specific prototypes can also be made with as little as one datasets that are already collected for clinical purposes, expanding on the current use of medical technology and existing testing.

Prototypes created using stereolithography are anatomically accurate because of the detailed layer-by-layer process used to print the prototype. A stereolithography printer can be configured with high resolution that allows precise anatomical structures to be depicted in the printed prototype. A three-dimensional printed model can be made to be patient specific based on the original computer tomography (CT) or magnetic resonance imaging (MRI) images used. The models can also be used as a functional base for anatomical deviations and pathophysiology. One approach is to add a layer of wax over the three-dimensional printed model, which is sculpted to create bumps, detailing, or other deviations that can be desired for a specific training model.

The uses for physiologically accurate tissue simulators are widespread. Organosilicate based materials can be subjected to extremes such as cuts, burns, gun shots, and blast pressures. They can then be repaired by the trainee as part of a simulated procedure. They can also be repaired via exposure to UV lighting, reducing their cost, and increasing their usage.

The tissue model materials, such as organosilicate base materials, can be modified based on reference to data from testing of actual tissue (living or cadaveric tissue), such as from human or animal cadavers. The physical properties that can be considered for soft tissues include homogeneity, nonlinear large deformation, anisotropy, viscoelasticity, strain rate insensitivity and compressibility. A tissue database can be created that includes tissue characteristics data that provide values for comparison with simulator materials.

The creation of a tissue property database can provide for accurate constitutive computer simulation models of structures, injury and disease. The primary components affecting the creation of artificial tissue models are material costs and supplies, accurate anatomical modeling, knowledge of the mechanical properties of the represented tissues, choosing the right materials, assemblage of the models in an accurate representation of anatomy, and model development based on educational principals and “backwards-design” with an embedded-assessment strategy to maximize the learning.

In an example, data regarding material properties of tissue to be simulated can be determined by harvesting soft-tissue specimens within 24 hours of death of a subject. The specimens can be warmed to body temperature and then subjected to uniaxial or biaxial testing to determine viscoelastic mechanical properties. In addition, electroconductive, thermoconductive, and indentation experiments can be performed on a plurality of different tissue types. The data can be stratified according to characteristics of the subject, such as gender, age, and body mass index (BMI).

In an example, data from the testing of the tissue samples can be used to form a tissue database, such as a human tissue database, which can be used to guide the formulation of organosilicate base material with the objective of tailoring the recipes of artificial tissues to match the properties of living tissue, such as living human tissue.

In an example, analyzing the similarities between human tissue materials and simulation materials can compare characteristics of their stress-strain curves. The stress-strain curves can be generated by a preprogrammed routine in Excel on an MTS computer based on inputted width, thickness, and initial displacement values and load vs. extension data.

Engineering stress is defined as a force per unit area:

$$σ = \frac{F}{A} \qquad [ 11 ]$$

where F is the applied force and A is the cross sectional area. Green strain is defined as:

$$G = \frac{1}{2} \frac{( {L}_{o} - {L}^{2} )}{{L}^{2}} \qquad [ 12 ]$$

where L₀ is the original length of the sample and L is the final length of the sample. The Young's modulus can be found by taking the slope of the stress-strain curve at the initial linear portion of the graph. Yield stress can be defined as the stress at which the material begins to break and can be found on the stress-strain curve as the maximum stress value on the stress-strain curve. The corresponding strain value can be defined as the strain at yield.

The data from the tissue database can allow tailoring of the organosilicate base material. Simulator models can be produced using commercially available off-the-shelf (COTS) organosilicate materials. The base material can undergo modifications to change cross-linking, electrical conductivity, thermal conductivity, reflectivity, indentation, odor, and color. Pigments and dyes can be added to the organosilicate material to create anatomically accurate color mapping of the simulator model.

Further details regarding the materials of the tissue model and other aspects of forming or evaluating use of the tissue models are described in; U.S. Provisional Patent Application Ser. No. 61/541,547, titled “Simulated, Representative High-Fidelity Organosilicate Tissue Models,” filed on Sep. 30, 2011; U.S. Provisional Patent Application Ser. No. 61/589,463, titled “Simulated, Representative High-Fidelity Organosilicate Tissue Models,” filed on Jan. 23, 2012; U.S. Provisional Patent Application Ser. No. 61/642,117, titled “Method for Analyzing Surgical Technique Using Assement Markers And Image Analysis,” filed May 3, 2012; U.S. application Ser. No. 13/630,715, titled “Simulated, Representative High-Fidelity Organosilicate Tissue Models,” filed on Sep. 28, 2012; PCT Application No. PCT/US2013/026933, titled “Systems and Methods For Analyzing Surgical Techniques,” filed on Feb. 20, 2013 and published on Nov. 7, 2013 as WO 2013/165529; and U.S. application Ser. No. 14/398,090, titled “Systems and Methods For Analyzing Surgical Techniques,” filed on Oct. 30, 2014, the disclosures of which are incorporated herein by reference as if reproduced in their entirety.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a molding system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented, at least in part. Some examples can include a computer-readable medium or machine-readable medium encoded with instructions operable to configure an electronic device to perform methods or method steps as described in the above examples. An implementation of such methods or method steps can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to allow the reader to quickly ascertain nature of the technical disclosure. It is submitted with the understanding that it will not be used to interpret or limit the scope or meaning of the claims.

Although the invention has been described with reference to exemplary embodiments, workers skilled in the art will recognize that changes may be made in form and detail without departing from the spirit and scope of the invention.

What is claimed is:

1. An anatomical simulation model comprising:
a first artificial bodily structure that simulates a corresponding first anatomical structure of a living body;
one or more second artificial bodily structures that simulate a corresponding second anatomical structure of the living body; and
one or more connectors to connect the first artificial bodily structure to the one or more second artificial bodily structures so that the first artificial bodily structure will move substantially in an anatomically accurate manner relative to the one or more second artificial bodily structures when an outside force is applied to the first artificial bodily structure.

2. The anatomical simulation model of claim 1, wherein the one or more connectors comprises one or more first connectors to directly connect the first artificial bodily structure to one of the one or more second artificial bodily structures.

3. The anatomical simulation model of claim 2, wherein the one or more connectors comprises one or more second connector to connect a first one of the second artificial bodily structures to a second one of the second artificial bodily structures.

4. The anatomical simulation model of claim 1, wherein each of the one or more connectors comprises at least one of a snap connector, Velcro, a fastener, a weld, a stitch, and an adhesive.

5. The anatomical simulation model of claim 1, wherein at least one of the one or more connectors is a releasable connector.

6. The anatomical simulation model of claim 1, wherein the outside force comprises at least one of: application of a medical device to one or more of the first artificial bodily structure or one or more of the second artificial bodily structure; application of a force onto one or more of the first artificial bodily structure and the one or more second artificial bodily structures; and movement of one or more of the first artificial bodily structure and at least one of the one or more second artificial bodily structures.

7. The anatomical simulation model of claim 1, wherein at least one of the first artificial bodily structure and the one or more second artificial bodily structures simulates one or more human anatomical structures.

8. An airway simulation model comprising:
an artificial first passageway that simulates a trachea;
an artificial neck structure, wherein the artificial first passageway is positioned in and extends at least partially along the artificial neck and is in communication with an artificial mouth structure; and
one or more connectors to connect the artificial first passageway to the artificial neck structure so that the artificial first passageway will move in an anatomically accurate manner relative to the artificial neck structure when an outside force is applied to the artificial first passageway.

9. The airway simulation model of claim 8, wherein the artificial first passageway simulates a human trachea and the artificial neck structure comprises one or more neck simulation structures that simulate one or more structures of a human neck.

10. The airway simulation model of claim 8, further comprising:
an artificial head structure coupled to the artificial neck structure, the artificial head structure comprising an artificial skull structure;
wherein the one or more connectors further comprise one or more cranial connectors between the artificial first passageway and the artificial skull structure so that the artificial first passageway will move in an anatomically accurate manner relative to the artificial neck structure and the artificial skull structure.

11. The airway simulation model of claim 10, wherein the artificial neck structure comprises one or more neck simulation structures that simulate one or more structures of a human neck and at least a portion of the artificial skull structure simulates at least a portion of a human skull.

12. The airway simulation model of claim 8, wherein the artificial neck structure comprises an artificial spine structure extending at least partially through the artificial neck structure, and wherein the one or more connectors comprise one or more spinal connectors between the artificial first passageway and the artificial spine structure.

13. The airway simulation model of claim 12, wherein the artificial neck structure comprises one or more neck simulation structures that simulate one or more structures of a human neck and the artificial spine structure comprises one or more spinal simulation structures that simulate at least a portion of a human spine.

14. The airway simulation model of claim 8, further comprising an artificial second passageway that simulates an esophagus, the artificial second passageway being positioned in and extending through the artificial neck structure and being adjacent to the artificial first passageway.

15. The airway simulation model of claim 14, wherein the artificial second passageway simulates a human esophagus and the artificial neck structure comprises one or more neck simulation structures that simulate one or more structures of a human neck.

16. The airway simulation model of claim 14, wherein the one or more connectors comprise one or more esophageal connectors between the artificial first passageway and the artificial second passageway.

17. The airway simulation model of claim 14, wherein the artificial neck structure comprises an artificial spine structure extending through the artificial neck structure, and wherein the one or more connectors comprise one or more spinal connectors between the artificial second passageway and the artificial spine structure.

18. The airway simulation model of claim 17, further comprising an artificial head structure coupled to the artificial neck structure, the artificial head structure comprising an artificial skull structure, and wherein the artificial neck structure comprises an artificial spine structure extending at least partially through the artificial neck structure, wherein the one or more connectors comprise:
one or more first connectors between the artificial first passageway and the artificial skull structure;
one or more second connectors between the artificial first passageway and the artificial spine structure;
one or more third connectors between the artificial first passageway and the artificial second passageway; and
one or more fourth connectors between the artificial second passageway and the artificial spine structure.

19. The airway simulation model of claim 18, wherein:
the artificial skull structure simulates at least a portion of a human skull and is coupled to the artificial spine structure,
the artificial head structure is coupled to the artificial neck structure,
the artificial neck structure comprises one or more neck simulation structures that simulate one or more structures of a human neck,
the artificial first passageway simulates a human trachea,
the artificial second passageway simulates a human esophagus, and
the artificial spine structure comprises one or more spinal simulation structures that simulate at least a portion of a human spine.

20. The airway simulation model of claim 10, wherein the outside force comprises at least one of: introduction of an intubation device into the artificial first passageway; movement of an artificial head that is coupled to the artificial neck structure; movement of the artificial neck structure; and movement of an artificial torso that is coupled to the artificial neck.
